(19) United States
(12) Patent Application Publication
(10) Pub. No.: US 2020/0174716 A1
(43) Pub. Date: Jun. 4, 2020

(54) IMAGE FORMING APPARATUS, IMAGE FORMING SYSTEM, AND IMAGE POSITION CORRECTION METHOD

(71) Applicant: KONICA MINOLTA, INC., Tokyo (JP)

(72) Inventor: Yoshiyuki HARADA, Tokyo (JP)

(73) Assignee: KONICA MINOLTA, INC., Tokyo (JP)

(21) Appl. No.: 16/671,645

(22) Filed: Nov. 1, 2019

(30) Foreign Application Priority Data
Nov. 29, 2018 (JP) 2018-223393

(51) Int. Cl. G06F 3/12; G06T 3/20; G06T 3/40

(52) U.S. Cl. CPC G06F 3/1208; G06T 3/40; G06T 3/20; G06F 3/1256

(57) ABSTRACT

Provided is an image forming apparatus that creates a part of a printed product including a first print medium on which a first image is preliminarily formed, the image forming apparatus includes an image former that forms an image on a print medium; an acquisitor that acquires image information in a print medium; and a hardware processor that, in a case of forming a second image on a second print medium that is a part of the printed product, controls the image former to form a third image on a third print medium, and to correct a position of the second image on the basis of image information of the first image and image information of the third image acquired from the acquisitor.

The entire disclosure of Japanese patent Application No. 2018-223393, filed on Nov. 20, 2018, is incorporated herein by reference in its entirety.

### BACKGROUND

### Technological Field

The present invention relates to an image forming apparatus, an image forming system, and an image position correction method.

### Description of the Related Art

In the creation of a predetermined printed product in image formation performed for a plurality of times in a conventional image forming apparatus, there have been cases where the image position shift occurs on a print medium in each of times of image formation. For example, JP 2014-144608 A discloses a configuration to suppress the position shift of images between the front and back of the sheet when creating a printed product in double-sided printing.

In addition, there are known predetermined printed products including a product created by distributed printing such as printing that combines a plurality of print media printed by a plurality of image forming apparatuses or printing that combines a plurality of different types of print media.

The printed product created by the distributed printing as described above involves a problem of an image position shift on each of print media due to individual differences of each of the plurality of image forming apparatuses or difference in the types of print media.

The configuration described in JP 2014-144608 A is not a configuration that takes distributed printing into consideration, and thus cannot solve the above problem.

### SUMMARY

An object of the present invention is to provide an image forming apparatus, an image forming system, and an image position correction method capable of suppressing the occurrence of image position shift on each of print media in distributed printing.

To achieve the abovementioned object, according to an aspect of the present invention, there is provided an image forming apparatus that creates a part of a printed product including a first pant medium on which a first image is preliminarily formed, and the image forming apparatus reflecting one aspect of the present invention comprises an image former that forms an image on a print medium, an acquisitor that acquires image information in a print medium, and a hardware processor that, in a case of forming a second image on a second print medium that is a part of the printed product, controls the image former to form a third image on a third print medium, and to correct a position of the second image on the basis of image information of the first image and image information of the third image acquired from the acquisitor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus ate not intended as a definition of the limits of the present invention:

FIG. 1 is a view schematically illustrating a whole configuration of an image forming system according to an embodiment of the present invention;

FIG. 2 is a diagram illustrating a main part of an entire control system provided in the image forming system according to the present embodiment;

FIG. 3 is a view illustrating an example of a first image on a first print medium and a second image on a second print medium;

FIG. 4 is a view illustrating the first print medium and the second print medium illustrated in FIG. 3 after cutting;

FIG. 5 is a view illustrating an example of the first print medium and the second print medium when an image position shift occurs;

FIG. 6 is a view illustrating the first print medium and the second print medium illustrated in FIG. 5 after cutting;

FIG. 7 is a view illustrating a method of comparing the first image on the first print medium with a third image on a third print medium;

FIG. 8 is a view illustrating a method of comparing the first image on the first print medium with the third image on the third print medium;

FIG. 9 is a view illustrating a method of comparing the first image and the third image when a cover mark is set as a reference object;

FIG. 10 is a view illustrating an example of a setting screen;

FIG. 11 is a view illustrating an example of a setting screen;

FIG. 12 is a flowchart illustrating an operation example when a controller executes correction control of the second image;

FIG. 13 is a flowchart illustrating an operation example when executing correction amount calculation control by the controller;

FIG. 14 is a table illustrating a list of operation modes; and

FIG. 15 is a view illustrating an example of the setting screen.

### DETAILED DESCRIPTION OF EMBODIMENTS

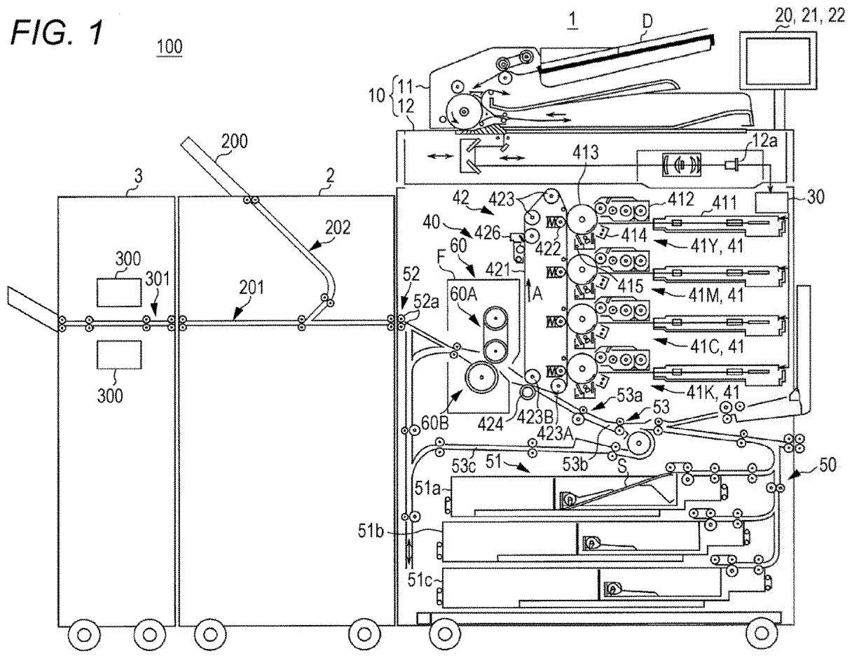

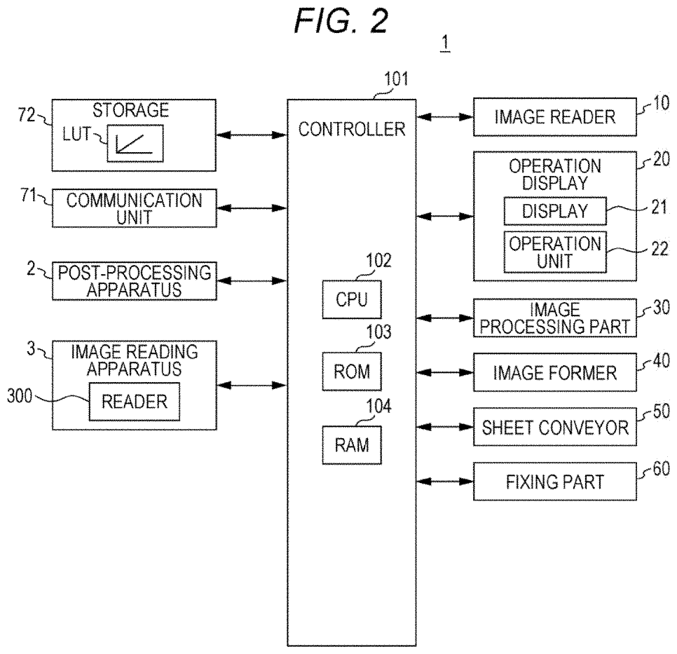

Hereinafter, one or more embodiments of the present invention will be described with reference to the drawings. However, the scope of the invention is not limited to the disclosed embodiments. FIG. 1 is a view schematically illustrating a whole configuration of an image forming system 100 according to an embodiment of the present invention. FIG. 2 is a diagram illustrating a main part of an entire control system provided in the image forming system 100 according to the present embodiment.

As illustrated in FIG. 1, the image forming system 100 includes an image forming apparatus 1, a post-processing apparatus 2, and an image reading apparatus 3, which are connected in order from the upstream side along a conveyance direction of a sheet S. The image forming system 100 operates by receiving a command from a personal computer (PC).

The image forming apparatus 1 is an intermediate transfer system color image forming apparatus utilizing an electrophotographic process technology. Specifically, the image forming apparatus 1 performs primary transfer of toner images of each of colors of yellow (Y), magenta (M), cyan (C), and black (K) formed on a photoconductive drum 413 to an intermediate transfer belt 421, and then, the toner images of the four colors are overlapped with each other on the intermediate transfer belt 421, so as to be transferred, in the secondary transfer, onto a sheet S fed from sheet feeding tray units 51a to 51c, thereby forming an image.

The image forming apparatus 1 adopts a tandem system in which the photoconductive drums 413 corresponding to the four colors of Y, M, C, and K are arranged in series in a running direction of the intermediate transfer belt 421, and the toner images of individual colors are sequentially transferred onto the intermediate transfer belt 421 in a single procedure.

As illustrated in FIG. 2, the image forming apparatus 1 includes an image reader 10, an operation display 20, an image processing part 30, an image former 40, a sheet conveyor 50, a fixing part 60, and a controller 101.

The controller 101 provided in the image forming apparatus 1 includes a central processing unit (CPU) 102, a read only memory (ROM) 103, and a random access memory (RAM) 104. The CPU 102 reads a program corresponding to processing content from the ROM 103, develops the program in the RAM 104, and centrally controls operation of each of blocks or the like of the image forming apparatus 1 in cooperation with the developed program. At this time, a variety of data stored in storage 72 is referenced. The storage 72 includes, for example, a nonvolatile semiconductor memory (or flash memory) and a hard disk drive.

The controller 101 transmits/receives various types of data to/from an external device (for example, a personal computer) connected to a communication network such as a local area network (LAN), a wide area network (WAN) via a communication unit 71. For example, the controller 101 receives image data (input image data) transmitted from an external device and controls to form an image on the sheet S on the basis of the image data. The communication unit 71 includes a communication control card such as a LAN card. The controller 101 is also connected with a controller of the post-processing apparatus 2 and 3 controller of the image reading apparatus 3, which will be described below.

As illustrated in FIG. 1, the image reader 10 includes an automatic document feeder (ADF) 11, and a document image scanner (scanner) 12.

The automatic document feeder 11 conveys a document D mounted in a document tray by a conveyance mechanism and feeds the document to the document image scanner 12. With the automatic document feeder 11, it is possible to collectively read images (including double-sided image) on a large number of the documents D placed in the document tray.

The document image scanner 12 optically scans the document conveyed onto a contact glass portion from the automatic document feeder 11 or the document placed on the contact glass portion, and reads a document image by collecting reflected light from the document to form an image on a light receiving plane of a charge coupled device (CCD) sensor 12a. The image reader 10 generates input image data on the basis of a reading result obtained by the document image scanner 12. The input image data undergoes predetermined image processing in the image processing part 30.

As illustrated in FIG. 2, the operation display 20 includes a liquid crystal display (LCD) having a touch screen, for example, and functions as a display 21 and an operation unit 22. According to a display control signal input from the controller 101, the display 21 displays various operation screens, states of images, individual function operation status, or the like. The operation unit 22 includes various operation keys such as a numeric keypad, and a start key, receives various input operation from a user, and outputs an operation signal to the controller 101.

The image processing part 30 includes a circuit for performing digital image processing corresponding to initial setting or user setting, on the input image data. For example, the image processing part 30 performs tone correction on the basis of tone correction data (tone correction table) under the control of the controller 101. In addition to the tone correction, the image processing part 30 applies various types of correction processing such as color correction, shading correction, compression processing, on the input image data. The image former 40 is controlled on the basis of the processed image data.

As illustrated in FIG. 1, the image former 40 includes image forming units 41Y, 41M, 41C, and 41K for forming images with color toners of a Y component, a M component, a C component, mid a K component, on the basis of the input image data, and includes an intermediate transfer unit 42.

The image forming units 41Y, 41M, 41C, and 41K for the Y component, the M component, the C component, and the K component have a similar configuration. For the convenience of illustration and explanation, components by which same explanation can be shared are denoted by a same reference sign, and Y, M, C, or K is added to the reference sign in a case where there is a need to distinguish between them. In FIG. 1, reference signs are representatively provided to the components of the image forming unit 41Y for the Y component and the reference signs of the components of the other image forming units 41M, 41C, 41K are omitted.

The image forming unit 41 includes an exposure device 411, a developing device 412, a photoconductive drum 413, a charging device 414, a drum cleaning device 415.

The photoconductive drum 413 is a negative charge type organic photoconductor (OPC) formed, for example, with an under coat layer (UCL), a charge generation layer (CGL), a charge transport layer (CTL), sequentially stacked on a peripheral surface of an aluminum conductive cylindrical body (aluminum pipe).

The controller 101 controls a drive current supplied to a driving motor (not illustrated) that rotates the photoconductive drum 413 so as to rotate the photoconductive drum 413 at a constant peripheral speed.

The charging device 414 uniformly negatively charges the surface of the photoconductive drum 413 having photoconductivity. The exposure device 411 includes a semiconductor laser, for example, and emits laser light corresponding to images of individual color components toward the photoconductive drum 413.

The developing device 412 is a two-component develop type developing device and forms a toner image by visualizing the electrostatic latent image by causing toner of each of the color components to adhere to the surface of the photoconductive drum 413.

The drum cleaning device 415 includes a drum cleaning blade that comes in sliding contact with the surface of the photoconductive drum 413, and removes transfer residual toner remaining on the surface of the photoconductive drum 413 after primary transfer.

The intermediate transfer unit 42 includes an intermediate transfer belt 421, a primary transfer roller 422, a plurality of support rollers 423, a secondary transfer roller 424, and a belt cleaning device 426.

The intermediate transfer belt 421 is formed with an endless belt and stretched in a loop around the plurality of support rollers 423. At least one of the plurality of support rollers 423 is constituted with a driving roller, and the other is (are) constituted by a driven roller. For example, it is preferable that a driving roller be implemented by a roller 423A disposed more toward the downstream side than the primary transfer roller 422 for the K component in the belt running direction. This facilitates holding the running speed of the belt at a constant level at a primary transfer part. The rotation of the driving roller 423A causes the intermediate transfer belt 421 to run in an arrow direction A at a constant speed.

The intermediate transfer belt 421 is a belt having conductivity and elasticity, and is rotationally driven by a control signal from the controller 101.

The primary transfer roller 422 is arranged on an inner peripheral surface side of the intermediate transfer belt 421 so as to face the photoconductive drum 413 of each of the color components. The primary transfer roller 422 comes in pressing contact with the photoconductive drum 413 having the intermediate transfer belt 421 in between, so as to form a primary transfer nip for transferring a toner image from the photoconductive drum 413 to the intermediate transfer belt 421.

The secondary transfer roller 424 is arranged on the outer peripheral surface side of the intermediate transfer belt 421 so as to face a backup roller 423B arranged on a downstream side in a belt running direction of the driving roller 423A. The secondary transfer roller 424 comes in pressing contact with the backup roller 423B having the intermediate transfer belt 421 in between, so as to form a secondary transfer nip for transferring a toner image from the intermediate transfer belt 421 to the sheet S.

When the intermediate transfer belt 421 passes through the primary transfer nip, toner images on the photoconductive drum 413 are overlapped and moistened sequentially onto the intermediate transfer belt 421 by primary transfer. Thereafter, when the sheet S passes through the secondary transfer nip, the toner image on the intermediate transfer belt 421 is transferred onto the sheet S, by secondary transfer. The sheet S on which the toner image has been transferred is conveyed toward the fixing part 60.

The belt cleaning device 426 removes the transfer residual toner remaining on the surface of the intermediate transfer belt 421 alter the secondary transfer.

The fixing port 60 includes an upper fixing part 60A and a lower fixing part 60B. The upper fixing part 60A includes a fixing surface-side member arranged on a toner image formation-side surface of the sheet S, that is, a fixing surface of the sheet S. The lower fixing part 60B includes a back surface side support member arranged on a side opposite to the fixing surface, that is, a back surface side of the sheet S. The back surface side support member comes in pressing contact with the fixing surface-side member, whereby a fixing nip for holding and conveying the sheet S is formed.

The fixing part 60 heats and pressurizes, at the fixing nip, the sheet S on which the toner image has been transferred by the secondary transfer, thereby fixing the toner image on the sheet S. The fixing part 60 is disposed as a unit in a fixing device F.

The sheet conveyor 50 includes a sheet feeder 51, a sheet discharger 52, a conveyance path part 53. In the three sheet feeding tray units 51a to 51c constituting the sheet feeder 51, the sheet S (standard sheets and special sheets) identified on the basis of the basis weight and size of the sheet S is contained being classified into each of preliminarily set types.

The conveyance path part 53 includes: a plurality of conveyance roller pairs such as a registration roller pair 53a; a normal conveyance path 53b that conveys the sheet S through the image former 40 and the fixing part 60 and so as to be discharged out of the apparatus; and a reverse conveyance path 53c that reverses front/back of the sheet S that has passed through the fixing part 60 and thereafter directs the sheet S to join the normal conveyance path 53b upstream of the image former 40. During double-sided printing, a toner image is formed on a front surface of the sheet S when the sheet S first passes through the normal conveyance path 53b. After passing through the reverse conveyance path 53c, a toner image is formed on a back surface of the sheet S when the sheet S passes through the normal conveyance path 53b again. The conveyance path part 53 corresponds to the “conveyor” of the present invention.

The sheets S contained in the sheet feeding tray units 51a to 51c are fed one by one from the top and are conveyed to the image former 40 by the conveyance path part 53. At this time, a registration roller part including a registration roller pair 53a collects inclination of the fed sheet S and adjusts a conveyance timing. Subsequently, the toner image on the intermediate transfer belt 421 is collectively transferred, by secondary transfer, onto one surface of the sheet S in the image former 40, and then, undergoes a fixing process in the fixing part 60. The sheet S carrying a formed image is discharged to the outside of the apparatus by the sheet discharger 52 having a sheet discharge roller 52a.

The sheets S contained in the sheet feeding tray units 51a to 51c are fed one by one from the top and are conveyed to the image former 40 by the conveyance path part 53. The toner image on the intermediate transfer belt 421 is collectively transferred, by secondary transfer, onto one surface of the sheet S in the image former 40, and then, undergoes a fixing process in the fixing part 60. The sheet S carrying a formed image is discharged to the outside of the apparatus by the sheet discharger 52 having a conveyance roller pair (sheet discharge roller pair) 52a.

The post-processing apparatus 2 is a device for inserting a print medium preliminarily printed by the image forming apparatus 1 or another image forming apparatus into a print medium formed by the image forming apparatus 1. The post-processing apparatus 2 includes a sheet feeding tray 200, a first conveyor 201, and a second conveyor 202.

The sheet feeding tray 200 is a tray for feeding a print medium carrying a preliminarily formed image to the post-processing apparatus 2. The first conveyor 201 forms a conveyance path for conveying the sheet S discharged from the image forming apparatus 1 to the image reading apparatus 3.

The second conveyor 202 forms a conveyance path for conveying the print medium disposed on the sheet feeding tray 200 to the first conveyor 201. The sheet feeding tray 200 is configured to use the second conveyor 202 to feed the print medium toward the image reading apparatus 3.

With a print medium inserted by the post-processing apparatus 2, the image forming system 100 can create one printed product that combines the print medium with the print medium formed by the image forming apparatus 1. In other words, providing the post-processing apparatus 2 in the image forming system 100 makes it possible to create one printed product by distributed printing.

Examples of a printed product created by such distributed printing include a product created by printing that combines a plurality of print media printed by a plurality of image forming apparatuses or printing that combines a plurality of different types of print media.

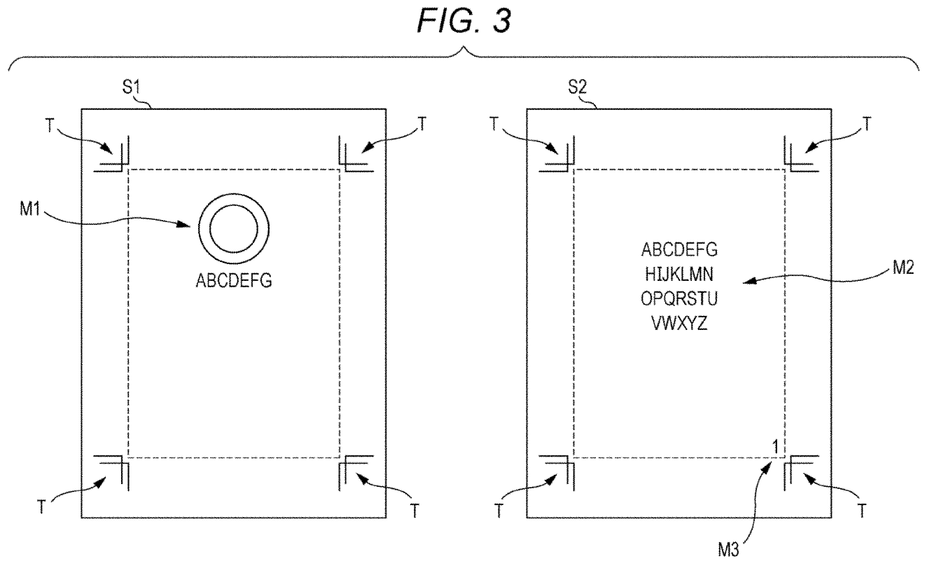

For example, as illustrated in FIG. 3, the following is a description of a case of creating a printed product by combining a first print medium S1 that forms a cover portion of a printed product and a second print medium S2 that forms a text portion of the printed product. Together with an image, a registration mark T serving as a reference for cutting by a cutter (not illustrated) is formed at four corners of each of print media.

In the following description, the first print medium S1 is a print medium fed from the sheet feeding tray 200 of the post-processing apparatus 2 and on which an image has been preliminarily formed, and the second print medium S2 is a print medium on which an image is formed by the image forming apparatus 1.

The first print medium S1 in FIG. 3 includes a registration mark T and a cover mark M1 formed as a first image. The second print medium S2 in FIG. 3 includes a registration mark T, a text M2, and a page number M3 formed as a second image. Additionally, the broken lines in FIG. 3 are cutting lines to be cut by the cutter.

In a case where the second print medium S2 to be printed in a print job includes a plurality of pages, the second image having a different text M2 and a page number M3 is to be formed on each of the second punt media S2.

In a case of creating such a printed product, first, the first print medium S1 on which the first image is preliminarily formed is set in the sheet feeding tray 200, and then the first print medium S1 is inserted by the post-processing apparatus 2 when the second image is formed on the second print medium S2 by the image forming apparatus 1. When the image formation on the second print medium S2 is completed, the printed product including the first print medium S1 and the second print medium S2 is cut by a cutter (not illustrated), thereby producing a finished printed product.

As illustrated in FIGS. 1 and 2, the image reading apparatus 3 is an apparatus that reads an image formed on a sheet S discharged from the image forming apparatus 1 or a print medium inserted from the post-processing apparatus 2. The image reading apparatus 3 includes a reader 300 and a read sheet conveyor 301.

The reader 300 is implemented by a scanner, for example, and is capable of reading an image formed on a print medium (sheet S).

The read sheet conveyor 301 is a conveyance path for discharging the print medium discharged from the post-processing apparatus 2 to the outside of the apparatus. The reader 300 is disposed one above and one below the read sheet conveyor 301, and reads an image formed on a print medium to be conveyed by the read sheet conveyor 301. After an image on the print medium has been read by the reader 300, the print medium is directly discharged out of the apparatus by the read sheet conveyor 301.

Image information read by the reader 300 is transmitted to the controller 101 of the image forming apparatus 1. In the case of setting the first print medium S1 and thereafter forming the second image on the second print medium S2 being a part of the printed product including the first print medium S1, the controller 101 controls the image former 40 so as to form a third image on a third print medium S3 before forming the second image on the second print medium S2.

Subsequently, the controller 101 controls the image former 40 so as to correct the position of the second image on the second print medium S2 on the basis of image information of the first image formed on the first print medium S1 and image information of the third image formed on the third print medium S3.

Correcting the position of the second image includes changing the position of the second image from the position in a print job, changing the size of the second image from the size in the print job, or a combination of these.

The third print medium is a position correction print medium for correcting the position of the second image. The third image is a position correction image for correcting the position of the second image. The third image may be the same image as the second image, or may be a different image from the second image. In the following description, the third image is assumed to be the same image as the second image of the first page, among the second images.

The controller 101 acquires image information of the first image and image information of the third image from the image reading apparatus 3, and corrects the second image in a case where their positional difference is larger than a predetermined value.

A printed product created by distributed printing might involve a problem of occurrence of an image position shift on each of print media due to individual differences among a plurality of image forming apparatuses and differences in the type of print medium. Examples of individual differences among the plurality of image forming apparatuses include a difference in sheet passing accuracy and a difference in apparatus settings. Examples of the difference in the type of print medium include a difference in the water content of the print medium in addition to the difference in the sheet type.

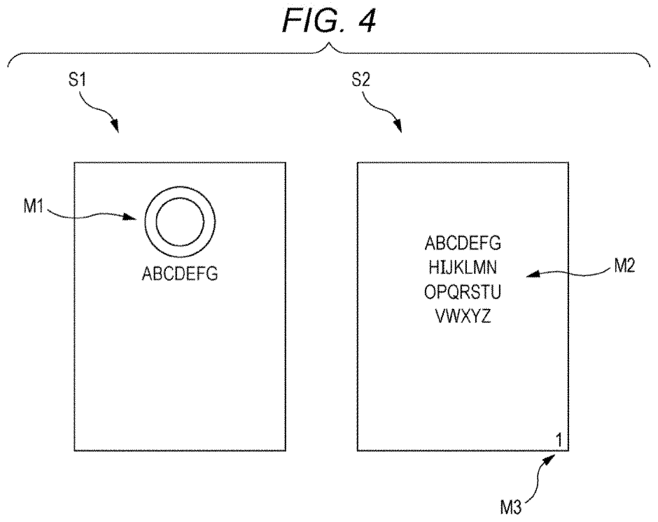

Such a printed product is obtained by cutting, by a cutter, for example, the print media collectively by stacking the first print medium S1 together with the second print medium S2 along the cutting line (refer to the broken line) in FIG. 3. In this case, when the position of the image on each of print media is a desired position, a printed product is created with each of print media in a desired state as illustrated in FIG. 4.

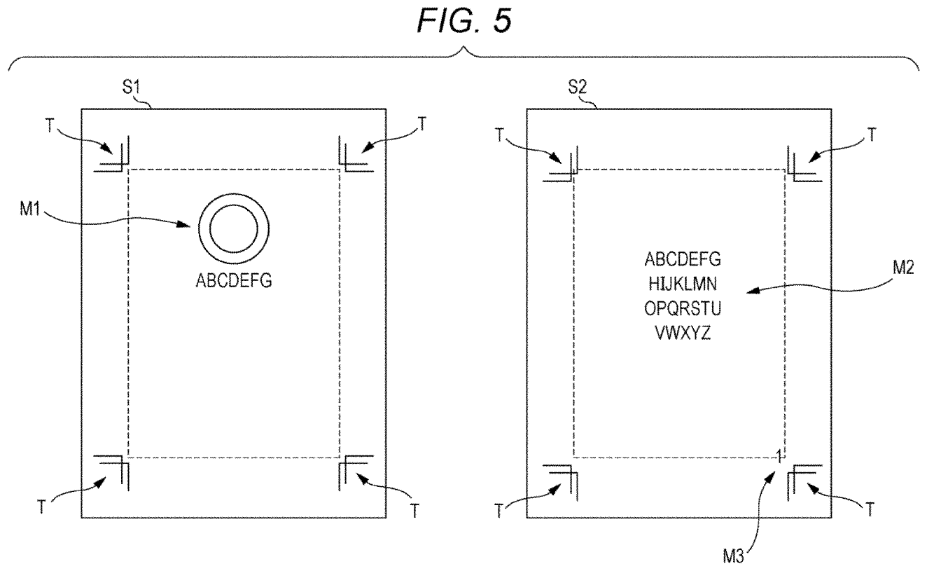

However, when the position of the image on each of print media is shifted, the positions of the registration marks T on individual print media have a difference, leading to misalignment of the cutting lines on each of print media, as illustrated in FIG. 5, for example.

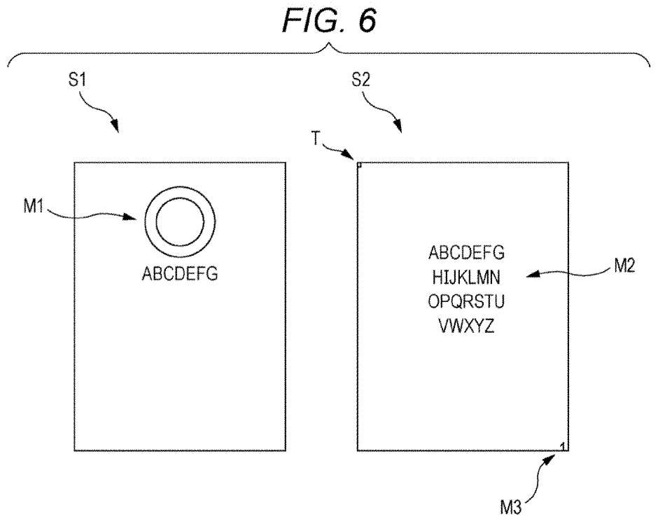

In a case, for example, where cutting is performed on the basis of the registration mark T of the first print medium S1, misalignment occurs in the cutting lines with the registration mark T of the second print medium S2. When the first print medium S1 and the second print medium S2 are cut together in such a case, the registration marks T might remain in the second print medium S2 after cutting (refer to an upper left corner of the second print medium S2), or the page number M3 is partially cut off as illustrated in FIG. 6. That is, a printed product including the second print medium S2 that is not in a desired state is created.

Therefore, in the present embodiment, the image information of the first image preliminarily formed on the first print medium S1 is compared with the image information of the third image for position correction formed on the third print medium S3 so as to extract a difference due to individual differences in the image forming apparatus 1 and the difference in the types of print media. Correcting the position of the second image on the second print medium S2 in consideration of the difference makes it possible to suppress the occurrence of the difference due to individual differences in the image forming apparatus 1 and the difference in the types of print media.

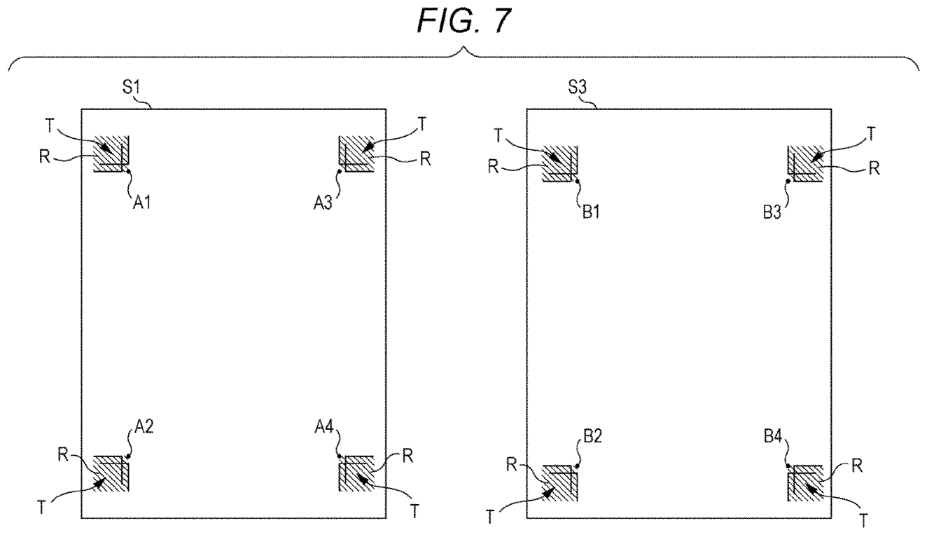

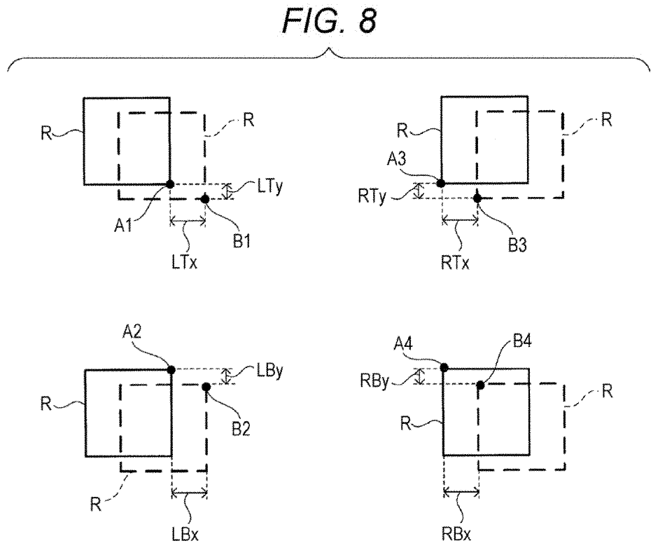

Next, a method for comparing the first image and the third image will be described. FIGS. 7 and 8 are views illustrating a method of comparing the first image on the first print medium S1 with the third image on the third print medium S3.

First, the controller 101 corrects the position of the second image on the basis of the position of a reference object in the image information of each of the first image and the third image. Examples of the reference object include a registration mark T attached to each of corners of the print medium together with individual images, a page number M3 of the print medium, a fixed image included in the image information, or a bleed edge portion on a print medium. Note that two or more of the registration mark T, the page number M3, the fixed image, and the bleed edge portion may be used as the reference object. In the following description, an example in which the reference object is a registration mark T will be described.

As illustrated in FIG. 7, the controller 101 uses the target apex at the position closest to the center of the print medium among the individual apexes in the rectangular region R (hatched portion) surrounding each of the registration marks T at four corners of the print medium for comparison between the first image and the third image.

The target apexes in the first image include a lower right apex A1 in the upper left registration mark T, an upper right apex A2 in the lower left registration mark T, a lower left apex A3 in the upper right registration mark T, and an upper left apex A4 in the lower right registration mark T. The target apexes in the third image include a lower right apex B1 in the upper left registration mark T, an upper right apex B2 in the lower left registration mark T, a lower left apex B3 in the upper right registration mark T, and an upper left apex B4 in the lower right registration mark T.

As illustrated in FIG. 8, the controller 101 overlays the first image and the third image, and calculates the difference in the position of the target apex of the registration mark at each corner. For the sake of convenience, FIG. 8 illustrates the region R in the four registration marks T alone. Furthermore, FIG. 8 omits illustration of the registration mark T in consideration of the visibility of the drawing.

The region R related to the first image in FIG. 8 is indicated by a solid line, and the region R related to the third image is indicated by a broken line. The comparison target of A1 of the first image is B1 of the third image, while the comparison target of A2 of the first image is B2 of the third image. The comparison target of A3 of the first image is B3 of the third image. The comparison target of A4 of the first image is B4 of the third image.

The controller 101 calculates the displacement between the first image and the third image at each of target apexes of each of registration marks in each of the vertical direction and the horizontal direction. A vertical displacement LTy of the upper left registration mark represents a difference value between the coordinates of A1 in the vertical direction and the coordinates of B1 in the vertical direction. A horizontal displacement LTx of the upper left registration mark represents a difference value between the coordinates of A1 in the horizontal direction and the coordinates of B1 in the horizontal direction.

A vertical displacement LBy of the lower left registration mark represents a difference value between the coordinates of A2 in the vertical direction and the coordinates of B2 in the vertical direction. A horizontal displacement LBx of the lower left registration mark represents a difference value between the coordinates of A2 in the horizontal direction and the coordinates of B2 in the horizontal direction.

A vertical displacement RTy of the upper right registration mark represents a difference value between the coordinates of A3 in the vertical direction and the coordinates of B3 in the vertical direction. A horizontal displacement RTx of the upper right registration mark represents a difference value between the coordinates of A3 in the horizontal direction and the coordinates of B3 in the horizontal direction.

A vertical displacement RBy of the lower right registration mark represents a difference value between the coordinates of A4 in the vertical direction and the coordinates of B4 in the vertical direction. A horizontal displacement RBx of the lower right registration mark represents a difference value between the coordinates of A4 in the horizontal direction and the coordinates of B4 in the horizontal direction.

After calculating individual displacements, the controller 101 calculates an average value of individual displacements in each of the vertical direction and the horizontal direction, and sets the value as a correction amount for the position of the second image. Specifically, the correction amount in the vertical direction is calculated by the formula:

(LTy+LBy+RTy+RBy)/4

The correction amount in the horizontal direction is calculated by the formula:

(LTx+LBx+RTx+RBx)/4

Note that the correction amount may be calculated by other methods.

On the basis of the displacement thus calculated, the controller 101 changes the position of the second image from the position at the print job (position of the third image), thereby correcting the position of the second image.

With this correction, as illustrated in FIG. 3, the registration mark position of the second print medium S2 is aligned with the registration mark position of the first print medium S1, enabling the second print medium S2 to be cut at a desired position. This leads to, as illustrated in FIG. 4, creation of a printed product with the print media in a desired state, making it possible to suppress occurrence of cut-off at a part of the image on the second print medium S2 and suppress the presence of residual portions of the registration mark.

Meanwhile, the magnification of the image might be sometimes different between the first image of the first print medium S1 and the second image of the second print medium S2. In such a case, correcting the position of the second image without considering the difference in magnification might lead to a failure in performing accurate correction.

In such a case, the controller 101 corrects the position of the second image with the size of the second image changed from the size in the print job. With this operation, it is possible to perform correction in consideration of the difference in magnification between the first image and the second image. Magnification is calculated, for example, by calculating the vertical length and the horizontal length of the rectangle formed by each of target apexes of the registration mark T in the first print medium S1 and the third print medium S3, individually.

Specifically, the vertical magnification can be calculated by dividing the vertical length of the first print medium S1 (for example, the difference value between the vertical coordinates of the target apex A1 and the vertical coordinates of the target apex A4) by the vertical length of the third print medium S3 (for example, the difference value between the vertical coordinate of the target apex B1 and the vertical coordinate of the target apex B4).

The horizontal magnification can be calculated by dividing the horizontal length of the first print medium S1 (for example, the difference value between the horizontal coordinates of the target apex A1 and the horizontal coordinates of the target apex A4) by the horizontal length of the third print medium S3 (for example, the difference value between the horizontal coordinate of the target apex B1 and the horizontal coordinate of the target apex B4).

After calculating the magnification, the controller 101 calculates the correction amount using the obtained magnification. Specifically, the vertical correction amount can be calculated by dividing the product of the vertical coordinate of the target apex on the third print medium S3 and the vertical magnification by the vertical coordinate of the target apex on the first print medium S1. The horizontal correction amount can be calculated by dividing the product of the horizontal coordinate of the target apex on the second print medium S2 and the horizontal magnification by the horizontal coordinate of the target apex on the first print medium S1. Note that the correction amount may be calculated by other methods.

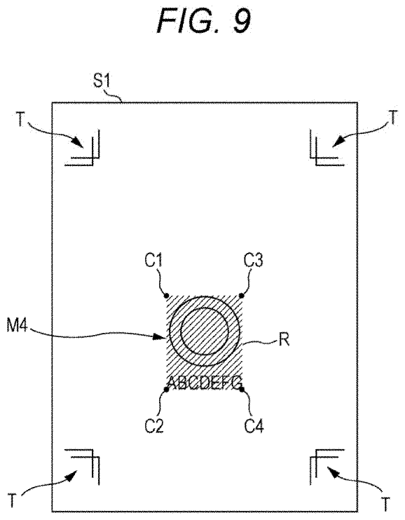

In another case where the object other than the registration mark T is used as the reference object, the correction amount can be calculated by a method similar to the above. For example, as illustrated in FIG. 9, when the reference object is the fixed image M4 included in the image information, the coordinates of the apexes C1, C2, C3, and C4 of the rectangular region R surrounding the fixed image M4 are acquired for each of the print media.

Subsequently, the difference values of each of the apexes C1, C2, C3, and C4 of the first print medium S1 and each of the apexes C1, C2, C3, and C4 of the third print medium S3, that is, the displacements are calculated, and an average value of these is set to be the correction amount of the second image.

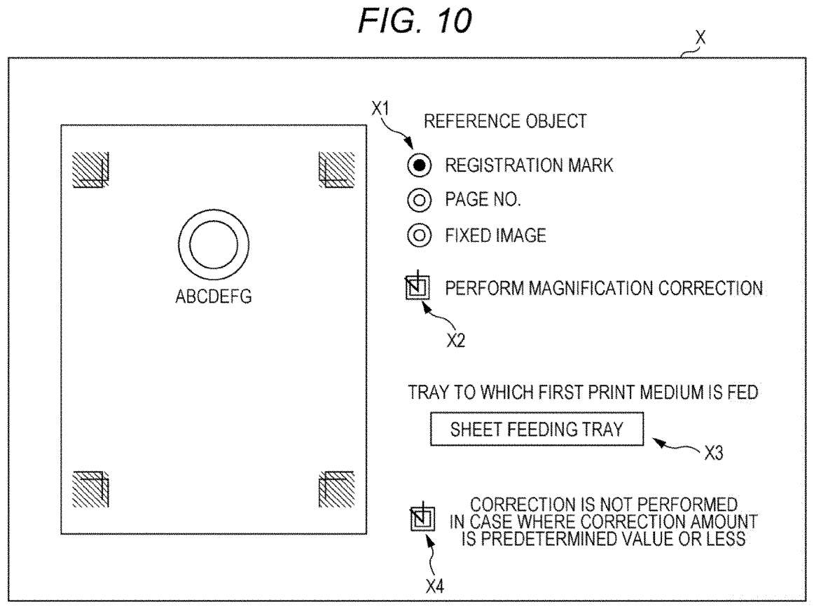

Furthermore, the setting of the reference object may be configured to be freely selected by the user as illustrated in FIG. 10, for example. FIG. 10 illustrates a setting screen X in user's image forming apparatus 1 such as a PC.

The user selects a desired reference object from the “reference object” on the setting screen X by checking checkbox X1. FIG. 10 illustrates an example in which “registration mark” is checked among “registration mark”, “page number”, and “fixed image”. Corresponding to this, the reference object checked on the setting screen will be hatched. In this manner, the user can easily select the reference object.

Furthermore, it is also allowable to configure such that whether to perform magnification correction may selectable on the setting screen X. For example, when the user wishes to perform magnification correction, the user checks checkbox X2 of “Perform magnification correction” in FIG. 10. In this manner, the user can easily select whether to perform magnification correction.

In the setting screen X, it is allowable to configure such that the tray to which the first print medium S1 is fed can be set as desired. The tray that has been set is displayed in a tray display part X3 on the setting screen X. Although FIG. 10 is an example in which the sheet feeding tray 200 is selected, the sheet feeding tray units 51a to 51e may be selected.

Furthermore, the controller 101 may determine whether to correct the position of the second image in accordance with a result of comparison between the image information of the first image and the image information of the third image. For example, in a case where the correction amount calculated above is a predetermined value (for example, 0.1 mm) or less, the controller 101 determines not to correct the position of the second image. For example, when the correction amount is a predetermined value or less, the user checks checkbox X4 “Correction is not performed in a case where the correction amount is a predetermined value or less” in FIG. 10. In this manner, the user can easily select whether the correction is to be performed.

In a case where there is not much difference by comparison of the image of the first print medium S1 and the image of the third print medium S3, the influence of individual differences of the device is considered to be low. In such cases, a desired printed product can be obtained without performing correction. Therefore, it is possible to suppress performing correction control pointlessly.

The controller 101 may determine whether to handle the third print medium S3 as the second print medium S2 in the print job or handle it as a position correction print medium for correcting the position of the second image in accordance with the result of comparison between the image information of the first image and the image information of the third image. For example, in a case where the correction amount calculated above is a predetermined value (for example, 0.1 mm) or less, the controller 101 handles the third print medium S3 as the second print medium S2 in the print job.

As described above, although the third print medium S3 is a print medium for correcting the position of the second image, the third print medium S3 can be handled as the second print medium S2 rather than a position correction medium in a case where the second image and the third image are the same image, and the first image and the third image has no difference and thus position correction of the second image is not to be performed. Therefore, in such a case, handling the third print medium S3 as the second print medium S2 makes it possible to reduce the number of printed sheets consumed due to the consumption of the position correction print media.

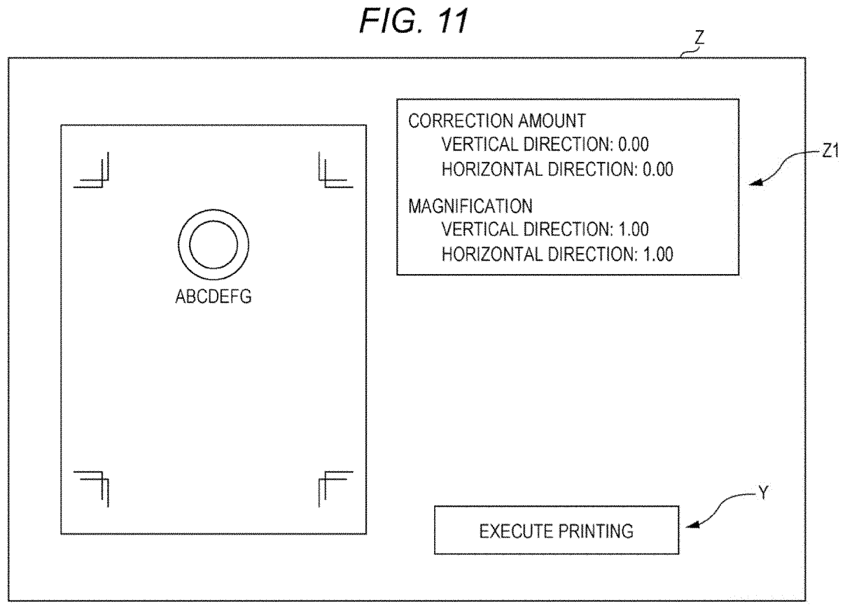

In addition, the controller 101 may perform control so that the calculated correction amount of the position of the second image is displayed on the display. Specifically, the controller 101 displays the calculated correction amount on a correction amount setter Z1 on a setting screen Z of a PC or the like, as an example of a display as illustrated in FIG. 11.

The correction amount setter Z1 in FIG. 11 displays the correction amount (vertical direction and horizontal direction) and the magnification (vertical direction and horizontal direction). Calculated correction amount and magnification are automatically input to this portion. FIG. 11 illustrates an example in which the correction amount is displayed as 0.00 in the vertical and horizontal directions, and the magnification is displayed as 1.00 in the vertical and horizontal directions.

This enables the user to easily confirm the correction amount of the second image of the second print medium S2.

Furthermore, the correction amount of the second image can be set by the user by using this setting screen Z. For example, the user can select any of “calculated correction amount or magnification” displayed in the correction amount setter Z1, and can use a numeric keypad or UP/DOWN keys (not illustrated) to perform setting by changing, by the user oneself, the selected correction amount or magnification.

With this configuration, the user can first grasp the value of the collection amount calculated by the controller 101, and then can perform fine adjustment of the correction amount as desired while confirming the image displayed on the left side of the correction amount setter Z1. As a result, the present embodiment makes it possible to freely select both the automatically calculated correction amount and the correction amount that matches the user's preference.

When the user clicks on a print execution part Y on the setting screen Z, the correction amount displayed on the correction amount setter Z1 is applied to an image to be printed on the second print medium S2.

The controller 101 may be configured to output a warning command in a case where the correction amount of the position of the second image is larger than a maximum correctable amount. The maximum correctable amount is an upper limit value of the correction amount of the position of the second image. The warning may be a sound such as a beep sound or voice guidance, or may be a display, on the display 21, or the like, of a situation in which the upper limit value of the correction amount is exceeded.

With this configuration, the user can easily grasp that the first image on the first print medium S1 and the third image on the third print medium S3 are shifted to an extent that cannot be corrected.

Furthermore, when the correction amount of the position of the second image is larger than the maximum correctable amount, the controller 101 may correct the position of the second image defining the correction amount as the maximum correctable amount in accordance with the difference between the correction amount and the maximum correctable amount. Specifically, when the difference between the correction amount and the maximum correctable amount is less than the predetermined value (for example, 0.1 mm), the controller 101 sets the correction amount of the second image as the maximum correctable amount.

When the correction amount is calculated to be 0.25 mm in a case where the maximum correctable amount is 0.2 mm, for example, the maximum correctable amount 0.2 mm is applied as the correction amount of the second image. This makes it possible to correct the position of the second image in a case where the difference between the correction amount and the maximum correctable amount is small, even when the correction amount exceeds the maximum correctable amount, leading to suppression of the position shift of the second image.

Moreover, the printed product to be created might sometimes include a fourth print medium on which a fourth image is formed in a print job different from the second print medium S2, in addition to the first print medium S1 and the second print medium S2. In this case, the controller 101 may determine the correction amount of the position of the fourth image on the basis of the correction amount of the position of the second image.

For example, in a printed product containing chaptered documents such as a cover page (first print medium), a document of Chapter 1 (second print medium), and a document of Chapter 2 (fourth print medium), there is a case where the document of Chapter 1 and the document of Chapter 2 are not formed by one continuous document. In such a case, printing is performed using different print jobs for the second print medium and the fourth print medium.

At this time, in a case where the second print medium and the fourth print medium are printed by the same image forming apparatus 1, there would be no individual difference in apparatus between the second print medium and the fourth print medium. Accordingly, position shift in the image to be formed is considered to be not so much. In this case, calculating the correction amount of the image position every time for each of the print job of the second print medium and the print job of the fourth print medium, regardless of the above situation, might complicate the control.

Therefore, in such a case, applying the correction amount of the position of the second image to the correction amount of the position of the fourth image would omit calculation of the correction amount of the position of the fourth image on the fourth print medium, making it possible to simplify the control.

Furthermore, the controller 101 may correct the position of the second image on the basis of the first image formed on the front surface out of both the front surface and the back surface of the first print medium S1.

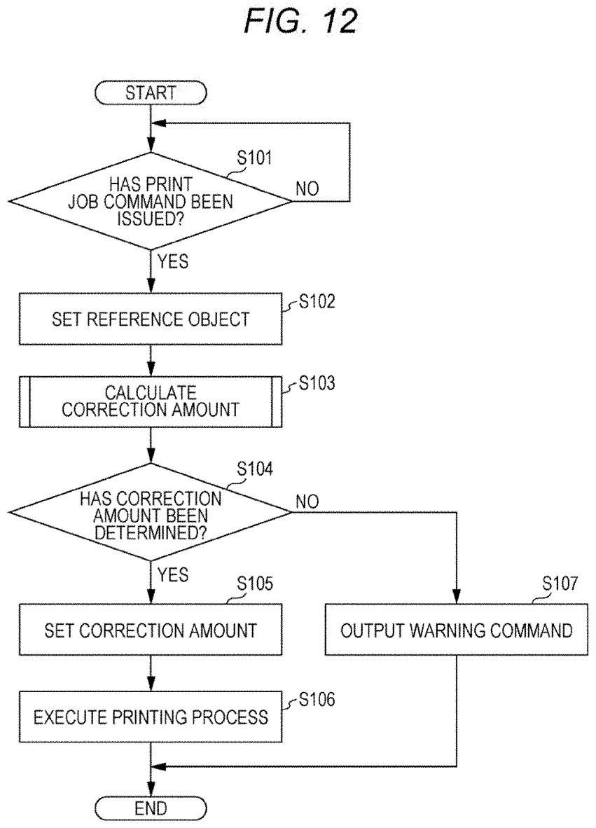

Next, an example of operation when the controller 101 executes correction control of the second image will be described. FIG. 12 is a flowchart illustrating an operation example when the controller 101 executes correction control of the second image. The processing in FIG. 12 is appropriately executed when the controller 101 receives a print job execution instruction after the first print medium S1 is set in the sheet feeding tray 200 of the post-processing apparatus 2.

As illustrated in FIG. 12, the controller 101 judges whether a print job command has been issued (step S101). In a case where it is judged that no print job command has been issued (step S101, NO), the processing of step S101 is repeated.

In contrast, in a case where a print job command has been issued (step S101, YES), the controller 101 sets a reference object (step S102). The setting of the reference object may be based on user setting or based on automatic setting on the controller 101.

Next, the controller 101 calculates the correction amount of the second image (step S103). Details of the processing of step S103 will be described below. The controller 101 judges whether the calculated correction amount has been determined (step S104).

In a case where it is judged that the correction amount is determined (step S104, YES), the controller 101 sets the calculated correction amount (step S105). Subsequently, the controller 101 executes a print process (step S106).

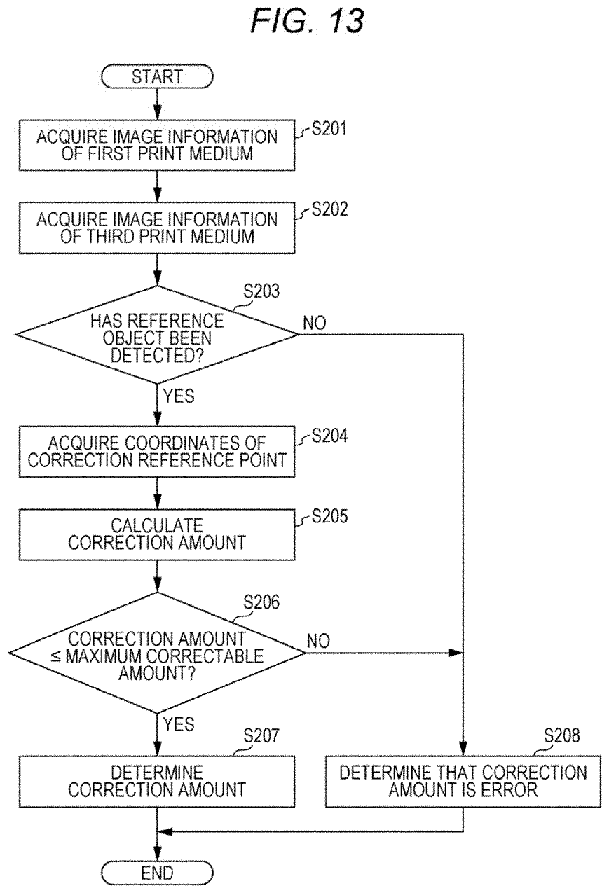

In contrast, in a case where the correction amount has not been determined (step S104, NO), the controller 101 outputs a warning command (step S107). The state in which the correction amount has not been determined indicates, for example, that the correction amount has been determined to be an error in step S208 in FIG. 13 to be described below. After step S106 or step S107, the present control is finished.

Next, details of the processing of step S103 in FIG. 12 will be described. FIG. 13 is a flowchart illustrating an operation example of executing the correction amount calculation control by the controller 101.

As illustrated in FIG. 13, the controller 101 acquires image information of the first print medium S1 (step S201). The controller 101 acquires image information of the third print medium S3 (step S202). In step S201 and step S202, when images are formed on both sides of each of print media, image information on both sides of each of print media is acquired.

Next, the controller 101 detects a reference object from the acquired image information (step S203). In a case where it is judged that the reference object has not been detected (step S203, NO), the processing transitions to step S208. In contrast, in a case where the reference object has been detected (step S203, YES), the controller 101 acquires coordinates of a correction reference point (step S204). The correction reference point is the target apex or the like described above.

Next, the controller 101 calculates a correction amount (step S205). In this process, when there is a magnification correction command, a correction amount considering the magnification correction is calculated. When there is no magnification correction command, a correction amount based on the position of the correction reference point is calculated.

Next, the controller 101 judges whether the collection amount is the maximum correctable amount or less (step S206). In a case where it is judged that the correction amount is the maximum collectable amount or less (step S206, YES), the controller 101 determines the correction amount (step S207).

In contrast, in a case where the correction amount is larger than the maximum correctable amount (step S206, NO), the controller 101 determines that the correction amount is an error (step S208). After step S207 or step S208, the present control is finished.

According to the present embodiment configured as described above, the position of the second image is corrected on the basis of the image information of the first image and the image information of the third image. Accordingly, it is possible to suppress the occurrence of image position shift in each of the print media in the distributed printing.

While the above embodiment is an example of performing position correction of the second image in the case of single-sided printing, the present invention is not limited to this, and the present invention may be applied to the position correction of the second image in the case of double-sided printing.

In this case, the controller 101 controls the image former 40 to form a back surface image on the back surface after forming the second image on the front surface of the print medium. In this case, the controller 101 may correct the position of the back surface image on the basis of the correction amount of the position of the second image.

In this manner, applying the correction amount on the front surface to the correction amount of the position of the back surface image makes it possible to save time and effort for calculating the correction amount of the position of the back surface image.

In addition, in the case of forming an image on both sides of the print medium, the controller 101 may determine the position of the back surface image on the basis of the preliminary settings.

In the case of performing double-sided printing, the amount of shift between the front surface and the back surface is preliminarily set on the image forming apparatus 1. Accordingly, the correction amount of the back surface image can be determined in consideration of the shift amount based on the preliminary setting with respect to the correction amount for the front surface image calculated on the basis of the first print medium S1. This leads to achievement of performing correction with higher accuracy. Furthermore, rending both the front and back surfaces of the third print medium S3 makes it possible to perform correction more efficiently rather than correcting the front and back surfaces separately.

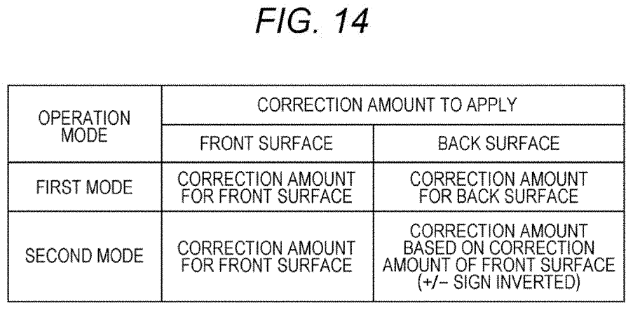

For correction of the second image and the back surface image in double-sided printing, for example, the controller 101 may be configured to be able to select an operation mode from the list of operation modes illustrated in FIG. 14.

As illustrated in FIG. 14, for example, selectable operation modes are a first mode and a second mode. Regarding the correction amount applied in the first mode, the correction amount calculated for the front surface (front surface correction amount) is applied to the front surface, and the correction amount calculated for the back surface (back surface correction amount) is applied to the back surface.

Regarding the correction amount applied in the second mode, the correction amount calculated for the front surface (front surface correction amount) is applied to the front surface, and the correction amount based on the correction amount for the front surface (+/− sign inverted) is applied to the back surface.

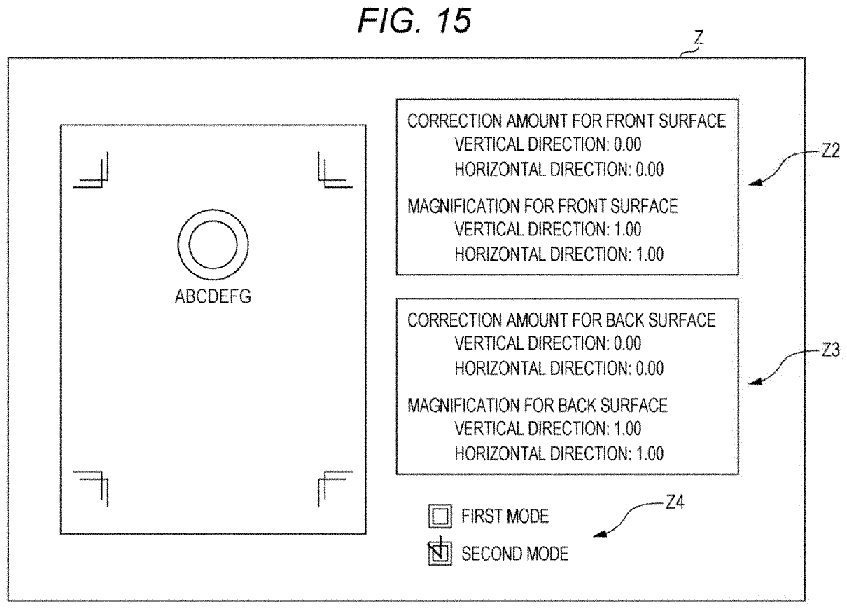

Such settings for the correction of the back surface image can be set on the setting screen Z or the like on the PC as illustrated in FIG. 15.

The setting screen Z includes a front surface correction amount setter Z2, a back surface correction amount setter Z3, and a mode selection part Z4.

The surface correction amount setter Z2 is a correction amount setter corresponding to the front surface. The back surface correction amount setter Z3 is a correction amount setter corresponding to the back surface. The front surface correction amount setter Z2 and the back surface correction amount setter Z3 are similar to the correction amount setter Z1 illustrated in FIG. 11.

The mode selection part Z4 includes checkboxes by which one of the first mode or the second mode is selectable. FIG. 15 illustrates an example in which the second mode is selected.

In this manner, the user selects one of the first mode or the second mode after confirming individual correction amounts in the front surface correction amount setter Z2 and the back surface correction amount setter Z3, making it possible to enhance the degree of freedom in adjusting the correction amount of the back surface.

In the above embodiment, the first print medium S1 is fed from the sheet feeding tray 200 of the post-processing apparatus 2. However, the present invention is not limited to this. For example, the first print medium S1 may be fed from a sheet feeder other than the sheet feeding tray 200, such as the sheet feeder 51 of the image forming apparatus 1.

In the above embodiment, the second image is corrected on the basis of the image information acquired from the image reading apparatus 3. However, the present invention is not limited to this, and the second image may be corrected on the basis of the image information read by the reader not connected to the image forming apparatus 1. That is the controller 101 may first acquire image information and then correct the second image on the basis of the acquired image information of the first image and the acquired image information of the third image.

The above embodiment uses the registration marks, page numbers, fixed images, and bleed edge portions as an example of reference objects. However, the present invention is not limited to this, and other objects may be used.

Although embodiments of the present invention have been described and illustrated in detail, the disclosed embodiments are made for purposes of illustration and example only and not limitation. The scope of the present invention should be interpreted by terms of the appended claims. That is, the present invention can be implemented in various forms without departing from the scope and spirit, or from the main features thereof.

What is claimed is:

1. An image forming apparatus that creates a part of a printed product including a first print medium on which a first image is preliminarily formed, the image forming apparatus comprising:
an image former that forms an image on a print medium;
an acquisitor that acquires image information in a print medium; and
a hardware processor that, in a case of forming a second image on a second print medium that is a part of the printed product, controls the image former to form a third image on a third print medium, and to correct a position of the second image on the basis of image information of the first image and image information of the third image acquired from the acquisitor.

2. The image forming apparatus according to claim 1,
wherein the hardware processor compares a position of a reference object included in the image information of the first image with a position of a reference object included in the image information of the third image, and determines the correction amount of the position of the second image on the basis of a result of the comparison.

3. The image forming apparatus according to claim 2,
wherein the reference object is at least one of a registration mark of the print medium, a page number of the print medium, a fixed image included in the image information, or bleed edge portion of the print medium.

4. The image forming apparatus according to claim 2,
wherein the hardware processor determines whether to correct the position of the second image in accordance with the result of the comparison.

5. The image forming apparatus according to claim 2,
wherein the hardware processor determines whether to handle the third print medium as the second print medium or a print medium for correcting the position of the second image in accordance with the result of the comparison.

6. The image forming apparatus according to claim 1,
wherein the hardware processor corrects the position of the second image by performing at least one of changing the position of the second image from the position in the print job, or changing the size of the second image from the size in the print job.

7. The image forming apparatus according to claim 1, further comprising
a conveyor that conveys the print medium so that an image can be formed on both the front surface and buck surface of the print medium,
wherein the hardware processor,
in a case of forming an image on the both sides of the print medium, controls the image former to first form the second image on the front surface and thereafter form a back surface image on the back surface, and
corrects the position of the back surface image on the basis of the collection amount of the position of the second image.

8. The image forming apparatus according to claim 1, further comprising:
a conveyor that conveys the print medium so that an image can be formed on both the from and back surfaces of the print medium; and
a setter for setting position adjustment between the position of the image to be formed on the from surface and the position of the image to be formed on the back surface,
wherein the hardware processor,
in the case of forming an image on the both sides of the print medium, controls the image former to first form the second image on the front surface and thereafter form a back surface image on the back surface, and
corrects the position of the back surface image on the basis of setting in the setter.

9. The image forming apparatus according to claim 1, further comprising
a display that displays a correction amount of the position of the second image.

10. The image forming apparatus according to claim 1,
wherein the hardware processor outputs a warning command in a case where a correction amount of the position of the second image is larger than a maximum correctable amount.

11. The image forming apparatus according to claim 1,
wherein, in a case where a correction amount of the position of the second image is larger than a maximum correctable amount, the hardware processor corrects the position of the second image by defining the correction amount as the maximum correctable amount in accordance with a difference between the correction amount and the maximum correctable amount.

12. The image forming apparatus according to claim 1,
wherein, in the case of forming a fourth image on a fourth print medium that is a part of the printed product in a print job different from the second print medium, the hardware processor determines a correction amount of the position of the fourth image on the basis of a correction amount of the position of the second image.

13. The image forming apparatus according to claim 1, further comprising
a conveyor that conveys the print medium so that an image can be formed on both the front and back surfaces of the print medium,
wherein, in the case of forming the second image on both sides of the second print medium, the hardware processor corrects the position of the second image on the back surface on the basis of the first image.

14. An image forming system including an image forming apparatus that creates a part of a printed product including a first print medium on which a first image is preliminarily formed, the image forming system comprising:
an image former that forms an image on a print medium;
a reader that reads image information in a print medium; and
a hardware processor that, in a case of forming a second image on a second print medium that is a part of the printed product, controls the image former to form a third image on a third print medium, and to correct a position of the second image on the basis of image information of the first image and image information of the third image acquired from the reader.

15. An image forming system according to claim 14, further comprising
a sheet feeding tray that is disposed in front of the reader and feeds a print medium toward the reader.

16. An image position correction method for an image forming apparatus that creates a part of a printed product including a first print medium on which a first image is preliminarily formed, the method comprising:
forming an image on a print medium;
acquiring image information in a print medium; and
in a case of forming a second image on a second print medium that is a part of the printed product, controlling the image former to form a third image on a third print medium, and to correct a position of the second image on the basis of acquired image information of the first image and acquired image information of the third image.
